(19) United States
(12) Patent Application Publication
(10) Pub. No.: US 2022/0003843 A1
(43) Pub. Date: Jan. 6, 2022

(54) LASER RADAR MOUNTING STRUCTURE

(71) Applicant: TOYOTA JIDOSHA KABUSHIKI KAISHA, Toyota-shi (JP)

(72) Inventors: Keisuke HOKAI, Gotemba-shi (JP); Shoichi HAYASAKA, Atsugi-shi (JP); Hiromitsu URANO, Numazu-shi (JP); Shuichi YOSHIKAWA, Gotemba-shi (JP)

(73) Assignee: TOYOTA JIDOSHA KABUSHIKI KAISHA, Toyota-shi (JP)

(21) Appl. No.: 17/339,191

(22) Filed: Jun. 4, 2021

(30) Foreign Application Priority Data
Jul. 3, 2020 (JP) 2020-115494

(51) Int. Cl. G01S 7/481; G01S 17/931

(52) U.S. Cl. CPC G01S 7/4813; G01S 17/931

(57) ABSTRACT

A laser radar mounting structure is a structure in which a first laser radar and a second laser radar for detecting an object around a vehicle are mounted to the vehicle. A detection direction of the first laser radar and a detection direction of the second laser radar are the same as each other. The first laser radar and the second laser radar are mounted such that a first light emitting unit and a second light emitting unit are located at different height positions.

### CROSS-REFERENCE TO RELATED APPLICATION

This application claims priority to Japanese Patent Application No. 2020-115494 filed on Jul. 3, 2020, incorporated herein by reference in its entirety.

### BACKGROUND

### 1. Technical Field

The present disclosure relates to a laser radar mounting structure.

### 2. Description of Related Art

For example, Japanese Unexamined Patent Application Publication No. 5-100029 (JP 5-100029 A) describes a vehicle equipped with a laser radar that detects an object. Two laser radars are mounted to the front part of the vehicle, and the two laser radars are used to detect an object in front of the vehicle.

### SUMMARY

The laser radar described above detects an object by irradiating multiple positions in the detection region with beams. In such a laser radar, there are gaps between the beams. Therefore, there may be a case where the object cannot be detected when the object is located between the emitted beams. In the device described in JP 5-100029 A, two laser radars provided at the same height position are arranged side by side in the horizontal direction, and detection is performed using the laser radars. However, in the device described in JP 5-100029 A, the emission angles of the beams emitted from the two laser radars in the up-down direction are the same as each other. Therefore, when the emitted beams are viewed in the lateral direction (lateral direction of the vehicle), the beams emitted from the two laser radars overlap each other. That is, even when two laser radars are used, the emitted beams pass through the same position as in the case of using one laser radar, as viewed in the lateral direction. Therefore, despite the use of two laser radars, the object could not be detected accurately.

The present disclosure describes a laser radar mounting structure that can improve the accuracy of detecting objects around a vehicle.

An aspect of the present disclosure provides a laser radar mounting structure for mounting a first laser radar and a second laser radar to a vehicle, the first laser radar and the second laser radar detecting an object around the vehicle. A detection direction of the first laser radar and a detection direction of the second laser radar are the same as each other. The first laser radar and the second laser radar are mounted such that a first light emitting unit and a second light emitting unit are located at different height positions in a height direction of the vehicle, the first light emitting unit being a light emitting unit of the first laser radar, and the second light emitting unit being a light emitting unit of the second laser radar.

In the laser radar mounting structure, the heights of the first light emitting unit and the second light emitting unit are different from each other. Therefore, when the emitted beams are viewed in the lateral direction, a plurality of beams is emitted at a plurality of emission angles in the up-down direction from the respective height positions at which the first light emitting unit and the second light emitting unit are installed. Thereby, when the emitted beams are viewed in the lateral direction, the beams emitted from the first light emitting unit and the beams emitted from the second light emitting unit do not pass through the same positions, but the beams emitted from the first light emitting unit and the beams emitted from the second light emitting unit intersect. That is, when the emitted beams are viewed in the lateral direction, the beams of the second light emitting unit can be emitted toward positions between the beams emitted from the first light emitting unit. Thereby, for example, even when there is an object between the beams emitted from the first light emitting unit, the beams of the second light emitting unit can increase the possibility that the object can be detected. As described above, in the laser radar mounting structure, the accuracy of detecting objects around the vehicle can be improved.

In the laser radar mounting structure, the height position of the second light emitting unit with respect to the first light emitting unit may be set such that a density of beams emitted from the first light emitting unit and the second light emitting unit is most uniform in a specific region around the vehicle, the specific region being relatively set in advance with respect to the vehicle. Here, when a predetermined region is uniformly irradiated with beams, the beams are more easily incident on an object in the predetermined region and the object can be detected more easily, as compared with the case where a part of the predetermined region is intensely irradiated with beams. In this way, the possibility that the object can be detected changes depending on whether the beams are uniformly emitted or unevenly emitted. Therefore, by setting the height position of the second light emitting unit with respect to the first light emitting unit such that the density of the beams is most uniform in the specific region, it is possible to increase the possibility that an object can be detected in the specific region compared with other regions. Thus, the laser radar mounting structure can increase the possibility that an object can be detected in the specific region set around the vehicle.

In the laser radar mounting structure, the first laser radar and the second laser radar may be mounted such that the first light emitting unit and the second light emitting unit are located on a reference axis extending along the height direction of the vehicle. In this case, there is no horizontal parallax between the detection result of the first laser radar and the detection result of the second laser radar. Thereby, for example, when performing a process of associating an object detected by the first laser radar with an object detected by the second laser radar, it is possible to easily associate the two recognition results. In this way, since there is no horizontal parallax, various processes using the two detection results can be easily performed. Therefore, the laser radar mounting structure facilitates the processes using the two detection results, thereby increasing the accuracy of detecting the object.

In the laser radar mounting structure, the detection direction of the first laser radar and the detection direction of the second laser radar may be oriented toward a side of the vehicle. In this case, in the laser radar mounting structure, the accuracy of detecting objects on the side of the vehicle can be improved.

In the laser radar mounting structure, the first laser radar and the second laser radar may be mounted to a side surface of the vehicle. In this case, in the laser radar mounting structure, the first laser radar and the second laser radar mounted to the side surface of the vehicle can accurately detect the object on the side of the vehicle without creating a blind spot.

According to the aspect of the present disclosure, it is possible to improve the accuracy of detecting objects around the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a right side view of a vehicle to which a first laser radar and a second laser radar are mounted with a laser radar mounting structure according to an embodiment;

FIG. 2A is a sectional view in the horizontal direction showing a periphery of a portion at which the second laser radar is mounted;

FIG. 2B is a view of the first laser radar and the second laser radar as viewed from the right side of the vehicle;

FIG. 3 is a beam pattern diagram of beams emitted from a laser radar as viewed in the lateral direction;

FIG. 4 is a view of positions on the ground on which the beams emitted from the laser radar are incident as viewed from above;

FIG. 5 is a beam pattern diagram of the beams emitted from the two laser radars as viewed in the lateral direction;

FIG. 6 is a beam pattern diagram of the beams emitted from the two laser radars as viewed in the lateral direction;

FIG. 7 is a top view showing a specific region set on the right side of the vehicle;

FIG. 8A is an example of a diagram showing cells through which the beams have passed;

FIG. 8B is another example of a diagram showing cells through which the beams have passed;

FIG. 8C is another example of a diagram showing cells through which the beams have passed;

FIG. 9 is a diagram showing changes in the number of voxels through which the beams pass when the height position of the second laser radar with respect to the first laser radar is changed; and

FIG. 10 is a front view of a vehicle to which three laser radars are mounted with a laser radar mounting structure according to a modification.

### DETAILED DESCRIPTION OF EMBODIMENTS

Hereinafter, an exemplary embodiment will be described with reference to the drawings. In the drawings, the same or corresponding elements will be denoted by the same reference signs, without redundant description. In the following description and the drawings, “front”, “rear”, “left”, and “right” are defined based on a vehicle V or V1.

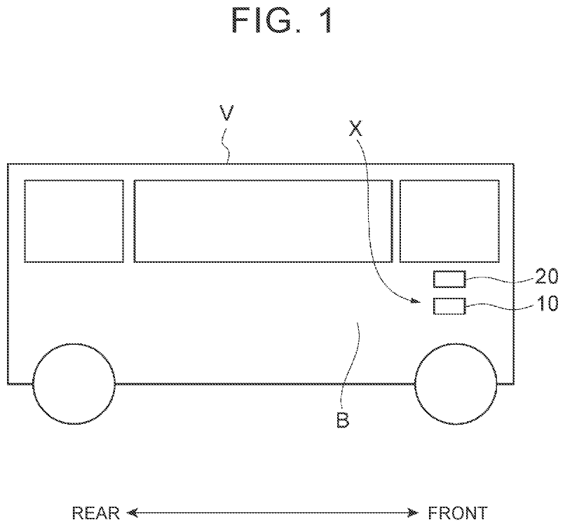

As shown in FIG. 1, a laser radar mounting structure X is a structure in which a first laser radar 10 and a second laser radar 20 are mounted to a side surface of a vehicle body of the vehicle V. The vehicle V may perform autonomous driving or provide driving support to a driver using detection results of the first laser radar 10 and the second laser radar 20. The vehicle V may be, for example, a bus on which a large number of passengers can board.

Although FIG. 1 shows a configuration in which the first laser radar 10 and the second laser radar 20 are mounted to a right side surface of the vehicle V with a laser radar mounting structure X, the first laser radar and the second laser radar are also mounted to a left side surface of the vehicle V with the laser radar mounting structure as to the right side surface. Hereinafter, the first laser radar 10 and the second laser radar 20 mounted to the right side surface will be described as representatives.

The first laser radar 10 and the second laser radar 20 are detection devices mounted on the vehicle V for detecting objects around the vehicle V. The detection direction of the first laser radar 10 and the detection direction of the second laser radar 20 are the same as each other. In the present embodiment, the detection directions of the first laser radar 10 and the second laser radar 20 are oriented toward the right side of the vehicle V. The wording “the detection directions are the same as each other” means that the first laser radar 10 and the second laser radar 20 are mounted so as to detect an object present in the same direction with respect to the vehicle V. The wording “the detection directions are the same as each other” includes a case where the first laser radar 10 and the second laser radar 20 are both facing toward the right side of the vehicle V, a case where both facing toward the left side of the vehicle V, a case where both facing forward of the vehicle V, or a case where both facing rearward of the vehicle V. The wording “the detection directions are the same as each other” includes a case where the optical axis directions (detection axial directions) of the first laser radar 10 and the second laser radar 20 are parallel. The wording “the detection directions are the same as each other” includes a case where the detection regions of the first laser radar 10 and the second laser radar 20 are both a region on the right side of the vehicle V, a case where the detection regions of the first laser radar 10 and the second laser radar 20 are both a region on the left side of the vehicle V, a case where the detection regions of the first laser radar 10 and the second laser radar 20 are both a region forward of the V, or a case where the detection regions of the first laser radar 10 and the second laser radar 20 are both a region rearward of the vehicle V.

The first laser radar 10 and the second laser radar 20 are each a light detection and ranging (LiDAR) as an example in the present embodiment. The first laser radar 10, which is a LiDAR, emits beams (laser light) to multiple positions on the right side of the vehicle V, and detects the object by receiving the beams reflected by the object. Similarly, the second laser radar 20 emits beams to the multiple positions on the right side of the vehicle V, and detects the object by receiving the beams reflected by the object.

In the present embodiment, the first laser radar 10 is a flash LiDAR capable of irradiating, with beams, multiple positions in the vertical direction and the horizontal direction at the same time. Similarly, the second laser radar 20 is a flash LiDAR. Further, the objects detected by the first laser radar 10 and the second laser radar 20 may be, for example, fixed objects such as guardrails and buildings, as well as moving objects such as pedestrians, bicycles, and other vehicles. The resolution of the first laser radar 10 and the resolution of the second laser radar 20 may be the same as each other or different from each other.

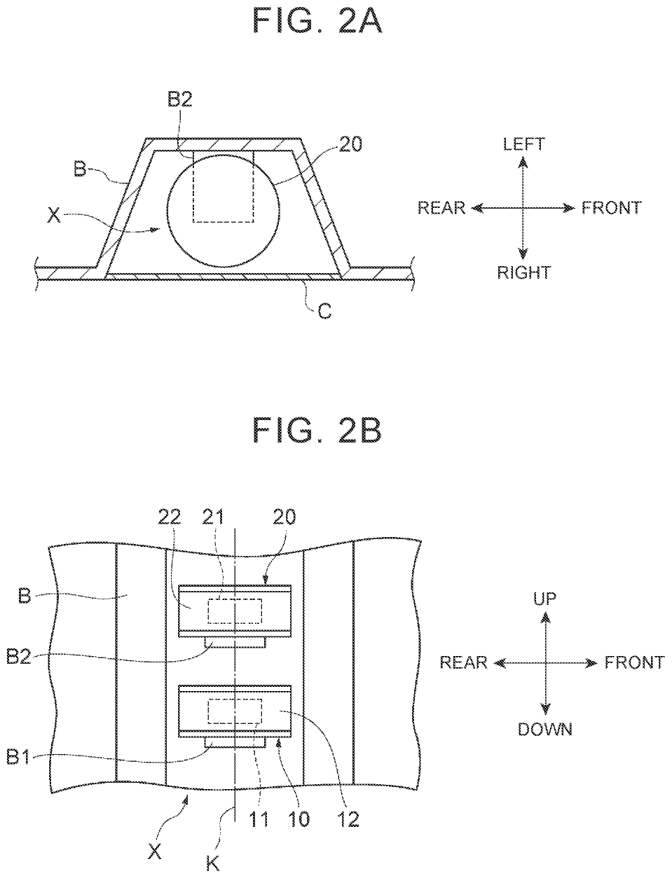

More specifically, the first laser radar 10 and the second laser radar 20 are mounted to the right side surface of a vehicle body B of the vehicle V in the vicinity of the front end portion of the vehicle V. In the present embodiment, as shown in FIGS. 2A and 2B, the first laser radar 10 and the second laser radar 20 are mounted in the recess provided in the vehicle body B. Further, as shown in FIG. 2A, a cover C may be mounted to the vehicle body B so as to cover the opening of the recess of the vehicle body B. In addition, in FIGS. 1 and 2B, the cover C is omitted in order to show the first laser radar 10 and the like in the recess of the vehicle body B.

The first laser radar 10 may be directly mounted to the vehicle body B, or may be mounted to the vehicle body B via a bracket B1. Similarly, the second laser radar 20 may be directly mounted to the vehicle body B, or may be mounted to the vehicle body B via a bracket B2.

As shown in FIG. 2B, the first laser radar 10 includes a first light emitting unit 11 that serves as an irradiation source of the beams. The first laser radar 10 emits beams from the first light emitting unit 11 toward the right side through a light projecting window 12 provided in the front surface of the first light emitting unit 11. Similarly, the second laser radar 20 includes a second light emitting unit 21 that serves as an irradiation source of the beams. The second laser radar 20 emits beams from the second light emitting unit 21 toward the right side through a light projecting window 22 provided in the front surface of the second light emitting unit 21.

As shown in FIG. 2B, the first laser radar 10 and the second laser radar 20 are mounted to the vehicle body B such that the first light emitting unit 11 and the second light emitting unit 21 are located at different height positions. In the present embodiment, the second laser radar 20 is mounted above the first laser radar 10, and the second light emitting unit 21 is located above the first light emitting unit 11. Further, the first laser radar 10 and the second laser radar 20 are mounted to the vehicle body B such that the first light emitting unit 11 and the second light emitting unit 21 are located on a reference axis K extending along the height direction (up-down direction) of the vehicle V.

Next, details of the beams emitted from the first laser radar 10 and the second laser radar 20 will be described. In the present embodiment, the first laser radar 10 and the second laser radar 20 each emit beams to the multiple positions in the up-down direction (vertical direction) and the horizontal direction. That is, the first laser radar 10 has a resolution of a predetermined angle in the up-down direction and a predetermined resolution in the horizontal direction. Similarly, the second laser radar 20 has a resolution of a predetermined angle in the up-down direction and a predetermined resolution in the horizontal direction.

First, a case where the beams are emitted only from the first laser radar 10 will be described. Here, the case where the beams are emitted from the first laser radar 10 installed at the position of a height A (m) will be described. The state in which the first laser radar 10 is installed at the position of the height A (m) means the state in which the first laser radar 10 is installed so that the first light emitting unit 11 is located at the position of the height A (m). The same applies to the similar description below.

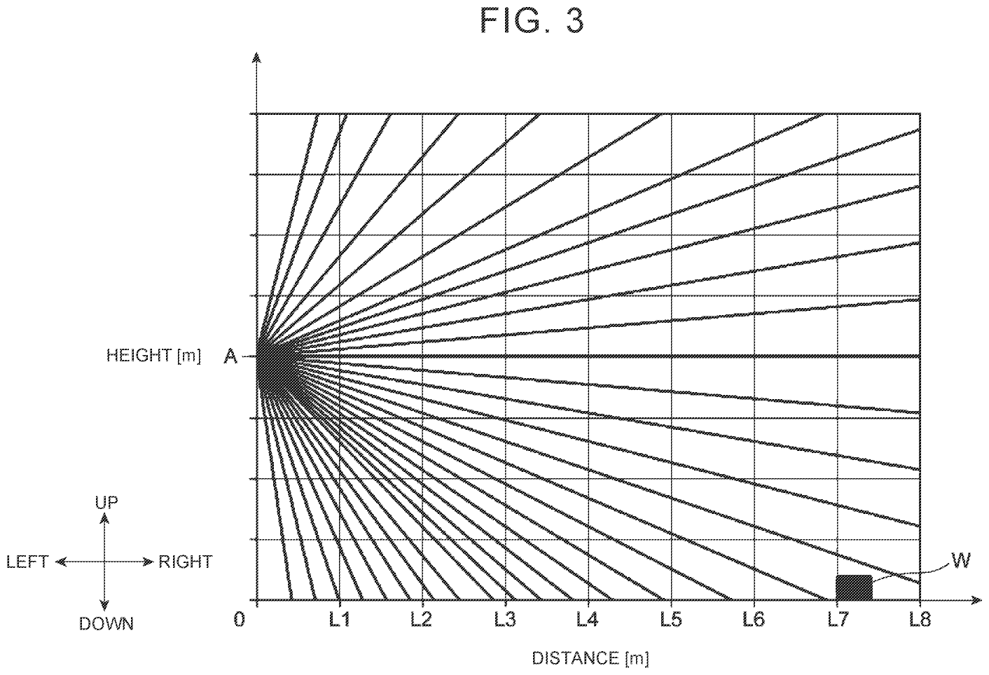

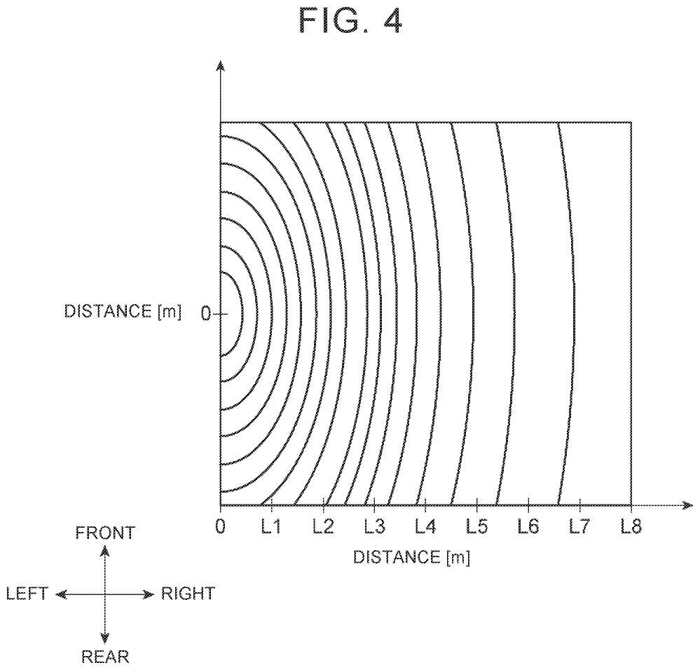

FIG. 3 shows trajectories of the beams emitted from the first laser radar 10 installed at the position of the height A (m) when the emitted beams are viewed in the lateral direction. The wording “when the emitted beams are viewed in the lateral direction” here means a case where the emitted beams are viewed from the front side or the rear side of the vehicle V in the horizontal direction in the present embodiment. The same applies to the similar description below. FIG. 4 shows the positions on the ground on which the emitted beams are incident when the beams are emitted toward the right side of the vehicle V from the first laser radar 10 installed at the position of the height A (m), as viewed from above.

Since a plurality of beams is emitted from the first laser radar 10 with a predetermined resolution in the up-down direction, there are gaps between adjacent beams as shown in FIG. 3, and there are also gaps between the positions at which the beams are incident on the ground in the lateral direction of the vehicle V, as shown in FIG. 4. Therefore, for example, as shown in FIG. 3, there is an object W on the ground in a region of the distance L7 to L8, but the first laser radar 10 cannot detect the object W because the object W is located between the beams.

Thus, in the present embodiment, the accuracy of detecting the object is improved by mounting the first laser radar 10 and the second laser radar 20 with the laser radar mounting structure X. Specifically, as described above, the first laser radar 10 and the second laser radar 20 are mounted such that the first light emitting unit 11 and the second light emitting unit 21 are located on the reference axis K. Hereinafter, a case where the beams are also emitted from the second laser radar 20 in addition to the first laser radar 10 will be described.

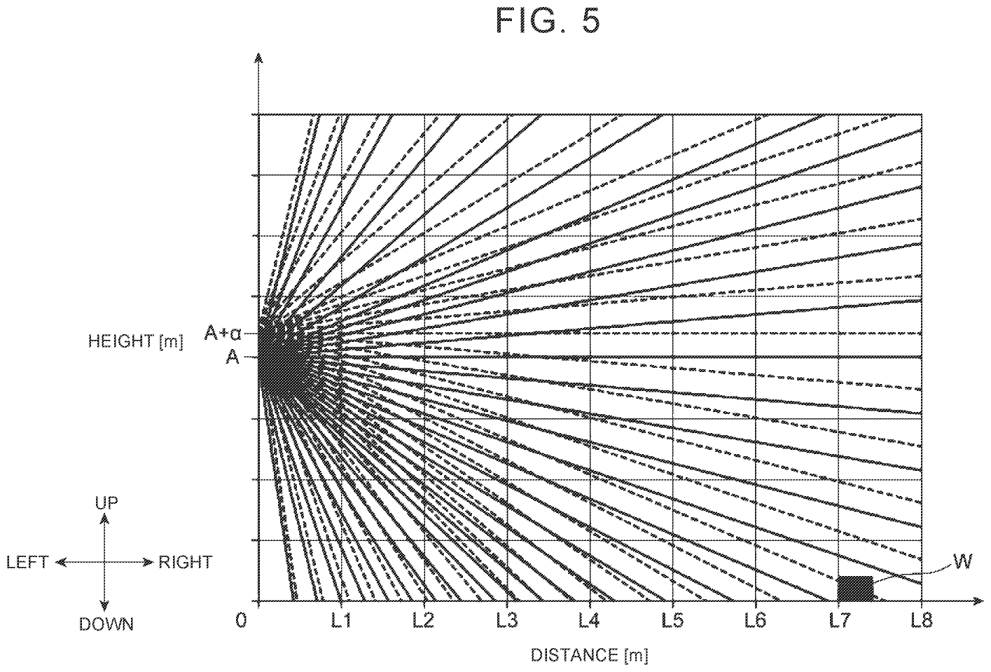

First, a case will be described in which beams are emitted from the first laser radar 10 and the second laser radar 20, with the first laser radar 10 (first light emitting unit 11) installed at the position of the height A (m) and the second laser radar 20 (second light emitting unit 21) installed at a position of a height A+α (m). In addition, α is a positive value. FIG. 5 shows the trajectories of the beams emitted from the first laser radar 10 and the second laser radar 20 when viewed in the lateral direction. In FIG. 5, the trajectories of the beams emitted from the first laser radar 10 installed at the position of the height A are shown by solid lines, and the trajectories of the beams emitted from the second laser radar 20 installed at the position of the height A+α are shown by broken lines.

As shown in FIG. 5, in a region of the distance L3 to L4 to the right from the mounting positions of the first laser radar 10 and the second laser radar 20 (hereinafter referred to as “laser radar mounting positions”), the beams of the first laser radar 10 and the second laser radar 20 substantially overlap each other in the up-down direction. Further, in the region of the distance L4 to L8 to the right from the laser radar mounting positions, the beams of the first laser radar 10 and the second laser radar 20 are separated from each other in the up-down direction.

Here, the state in which the beams are separated from each other means a state in which the density of the beams is more uniform without unevenness in a predetermined region (three-dimensional region) as compared with the state in which the beams overlap each other (a state of uniform irradiation). For example, in the example shown in FIG. 5, the density of the beams is more uniform in the region of the distance L7 to L8 than in the region of the distance L3 to L4. In other words, the state in which the density of the beams is more uniform means a state of a higher degree of dispersion of the beams.

Thus, for example, as shown in FIG. 5, when there is the object W on the ground in the region of the distance L7 to L8, the object W cannot be detected only by the beams emitted from the first laser radar 10 shown by the solid line. However, with the irradiation of the beams from the second laser radar 20 shown by the broken lines between the beams from the first laser radar 10, the object W can be detected by the second laser radar 20.

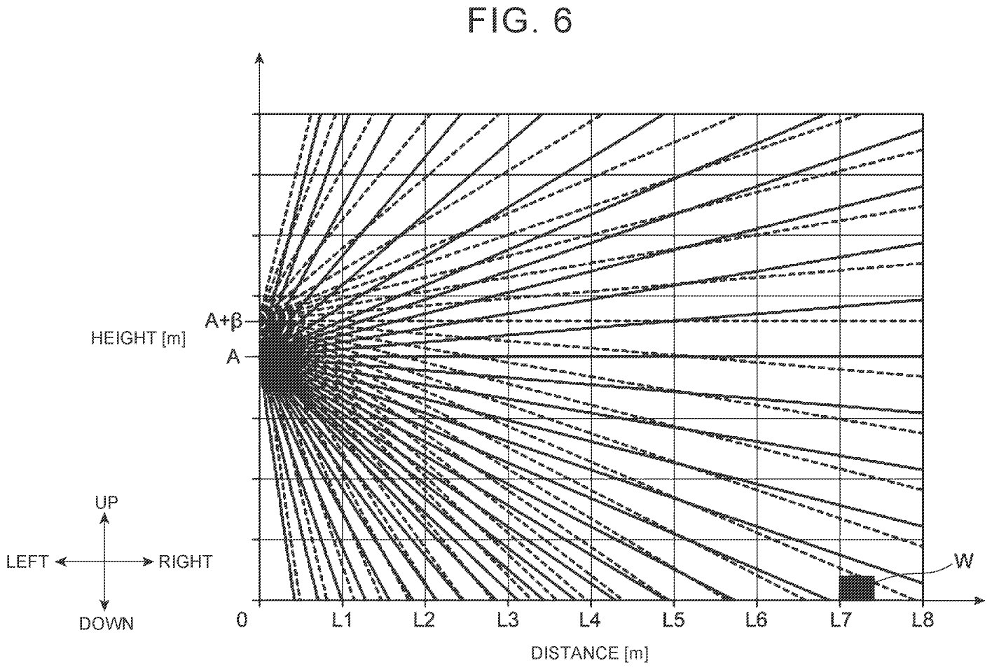

Next, a case will be described in which beams are emitted from the first laser radar 10 and the second laser radar 20, with the first laser radar 10 (first light emitting unit 11) installed at the position of the height A (m) and the second laser radar 20 (second light emitting unit 21) installed at a position of a height A+β (m). Note that β is a positive value larger than α. FIG. 6 shows the trajectories of the beams emitted from the first laser radar 10 and the second laser radar 20 when viewed in the lateral direction. That is, the mounting height position of the second laser radar 20 shown in FIG. 6 is higher than the mounting height position of the second laser radar 20 shown in FIG. 5. In FIG. 6, the trajectories of the beams emitted from the first laser radar 10 installed at the position of the height A are shown by solid lines, and the trajectories of the beams emitted from the second laser radar 20 installed at the position of the height A+β are shown by broken lines.

As shown in FIG. 6, in the region of the distance L3 to L4 to the right from the laser radar mounting positions, the beams of the first laser radar 10 and the second laser radar 20 are separated from each other in the up-down direction, and the density of the beams is uniform. In the region of the distance L4 to L6 to the right from the laser radar mounting positions, the beams of the first laser radar 10 and the second laser radar 20 substantially overlap each other in the up-down direction (that is, the density of the beams is not uniform). As shown in FIG. 6, in the region of the distance L6 to L8 to the right from the laser radar mounting positions, the beams of the first laser radar 10 and the second laser radar 20 are separated from each other in the up-down direction, and the density of the beams is uniform again.

As is clear from FIGS. 5 and 6, with the change of the mounting height position of the second light emitting unit 21 with respect to the first light emitting unit 11, the region where the density of the beams is uniform changes. Thus, it is not possible to make the density of the beams uniform in all the regions where the detection ranges of the first laser radar 10 and the second laser radar 20 overlap each other. However, for example, a predetermined region is set, and the mounting height positions of the first light emitting unit 11 and the second light emitting unit 21 can be determined such that the density of the beams is most uniform in the predetermined region. Thereby, the object can be accurately detected within the set predetermined region.

Hereinafter, a method of setting the height position of the second laser radar 20 (second light emitting unit 21) with respect to the first laser radar 10 (first light emitting unit 11) such that the density of the beams is most uniform within the set predetermined region will be described. In the following, the predetermined region (the set predetermined region) in which the density of the beams is most uniform will be referred to as “specific region”. By making the density of the beams most uniform in the specific region, the accuracy of detecting the object especially in the specific region can be increased while the object can be detected in regions other than the specific region.

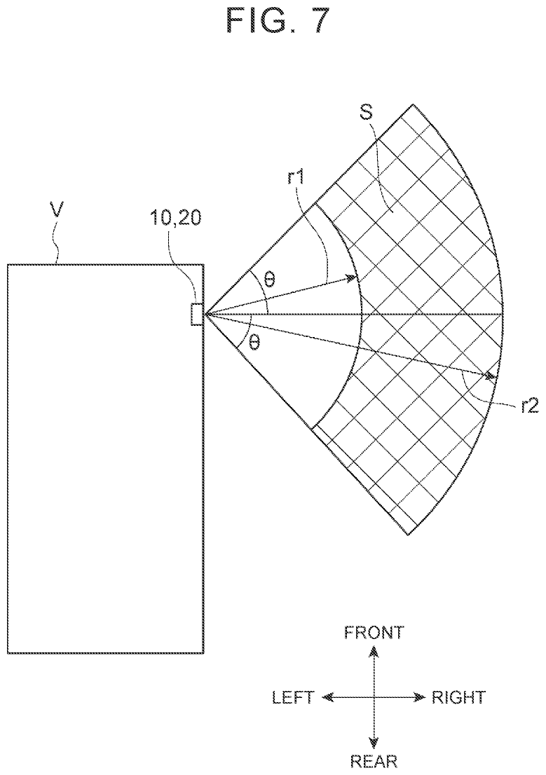

First, an example of setting the specific region will be described. As shown in FIG. 7, in the present embodiment, a specific region S is set on the right side of the vehicle V. Specifically, the specific region S is set in a region where the detection range of the first laser radar 10 and the detection range of the second laser radar 20 overlap. Here, as an example, the specific region S is set as a region ranging from θ (deg.) forward to θ (deg.) rearward with respect to a direction directly next to the vehicle V, ranging from a distance r1 (m) to a distance r2 (m) from the laser radar mounting positions, and ranging from the ground (0 (m)) to a height h (m). That is, the specific region S is a three-dimensional space.

However, in the example shown in FIG. 7, a case where a generally fan-shaped specific region S is set directly next to the vehicle V as viewed from above is shown, but the shape of the specific region S is not limited to the fan shape. The shape of the specific region S may be various shapes such as a rectangle as viewed from above. Further, the lower value of the height range of the specific region S does not have to be the height position of the ground. Thus, the specific region S may be a region around the vehicle V that is set in advance relative to the vehicle V depending on the object or the like to be detected. As an example, the specific region S may be set as a region including a road shoulder on the right side of the vehicle V in order to accurately detect a pedestrian or the like that is about to cross the traveling lane of the vehicle V. As an example, the specific region S may be set as a region including a road surface at a predetermined distance (for example, 10 m away) on the right side of the vehicle V in order to accurately detect another vehicle or the like on the right side at an intersection or the like.

In the specific region S set in this way, the height position of the second light emitting unit 21 with respect to the first light emitting unit 11 is set such that the density of the beams emitted from the first laser radar 10 and the second laser radar 20 is most uniform.

Here, as an example, it is possible to determine whether the density of the beams is most uniform in the specific region S based on the ratio of voxels through which the beams pass to the voxels set in the specific region S.

Specifically, first, the specific region S is divided into three-dimensional voxels. Then, the ratio of the voxels through which the beams have passed to all the voxels in the specific region S is obtained. As described with reference to FIGS. 5 and 6, the trajectories of the beams change with the change in the height position of the second light emitting unit 21 with respect to the first light emitting unit 11, and the ratio of voxels through which the beams pass also changes. When the beams are evenly distributed, the number of voxels through which the beams pass increases. The state in which the ratio of voxels through which the beams pass (the number of voxels) is the largest represents the state in which the beams are most uniform in the specific region S.

Therefore, the height position of the second light emitting unit 21 with respect to the first light emitting unit 11 is changed, and the ratio of voxels through which the beams pass is obtained for each height position. The height position of the second light emitting unit 21 with respect to the first light emitting unit 11 when the ratio of voxels through which the beams pass is largest realizes a mounting state that can make the density of the beams most uniform in the specific region S. Thus, the height position of the second light emitting unit 21 with respect to the first light emitting unit 11 for making the density of the beams most uniform in the specific region S can be determined based on the ratio of voxels through which the beams pass.

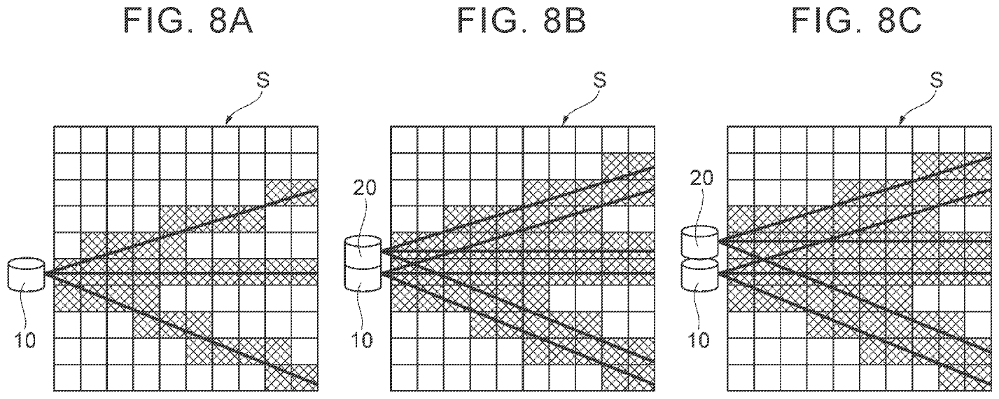

Hereinafter, a method for determining whether the density of the beams is uniform using voxels will be briefly described using two-dimensional cells. FIG. 8A is a side view of the beams emitted from the first laser radar 10. Similarly, FIGS. 8B and 8C are side views of the beams emitted from the first laser radar 10 and the second laser radar 20. In FIGS. 8A to 8C, the number of beams is reduced as compared with the case shown in FIG. 5 and the like in order to facilitate the explanation. Further, FIGS. 8A to 8C show a case where the specific region S shown in two dimensions is divided into 100 cells of 10×10. In FIGS. 8A to 8C, the cells through which the beams have passed are hatched.

As shown in FIG. 8A, when the beams are emitted only from the first laser radar 10, the beams pass through 33 cells out of the 100 cells. FIG. 8B shows a case where the beams are emitted from the second laser radar 20 in addition to the first laser radar 10. In this case, as shown in FIG. 8B, the beams pass through 51 cells out of the 100 cells. FIG. 8C shows a case where the beams are emitted from the second laser radar 20 in addition to the first laser radar 10. In addition, in FIG. 8C, the position of the second laser radar 20 (second light emitting unit 21) is higher than in the case shown in FIG. 8B. In this case, as shown in FIG. 8C, the beams pass through 57 cells out of the 100 cells. In this way, by changing the height position of the second light emitting unit 21 with respect to the first light emitting unit 11, the number of cells through which the beams pass also changes. Therefore, by changing the height position of the second light emitting unit 21 with respect to the first light emitting unit 11 and counting the number of cells through which the beams pass, it is possible to determine whether the density of the beams is most uniform in the specific region S.

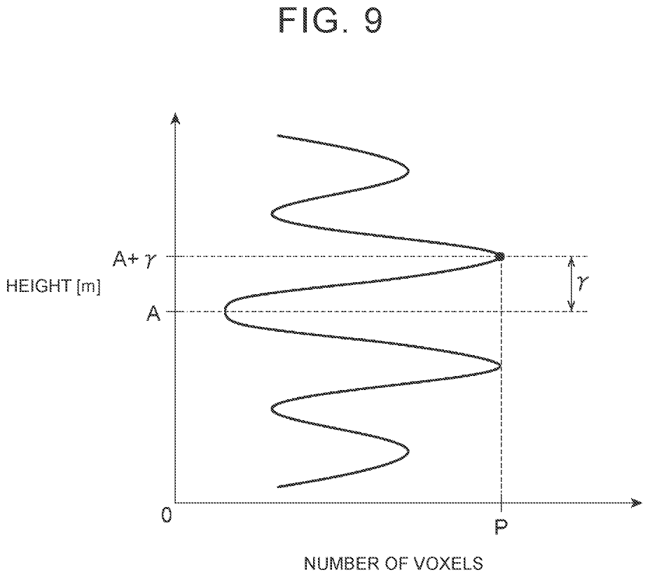

Here, FIG. 9 shows an example of changes of the number of voxels through which the beams pass in the specific region S in the case where the first laser radar 10 (first light emitting unit 11) is fixed at the position of the height A (m) and the height of the second laser radar 20 (second light emitting unit 21) is changed. Here, for example, when the second laser radar 20 (second light emitting unit 21) is installed at a position of a height A+γ (m), the number of voxels through which the beams emitted from the first laser radar 10 and the second laser radar 20 pass is P. Thus, with the change in the height position of the second laser radar 20 with respect to the first laser radar 10, the number of voxels through which the beams pass increases and decreases.

In the figure representing the increase and decrease in the number of voxels shown in FIG. 9, the shape of the waveform differs depending on the beam patterns of the first laser radar 10 and the second laser radar 20, the way of setting the specific region S, and the size of the voxels. However, when the height position of the first laser radar 10 (first light emitting unit 11) is fixed and the height position of the second laser radar 20 (second light emitting unit 21) is changed, a peak in the number of voxels through which the beams pass occur at any of the height positions. By mounting the first laser radar 10 and the second laser radar 20 so as to establish a positional relationship at the time of that peak, the density of the beams can be made most uniform in the specific region S.

As described above, in the laser radar mounting structure X, the heights of the first light emitting unit 11 and the second light emitting unit 21 are different from each other. Therefore, when the emitted beams are viewed in the lateral direction, a plurality of beams is emitted at a plurality of emission angles in the up-down direction from the respective height positions at which the first light emitting unit 11 and the second light emitting unit 21 are installed (see FIGS. 5 and 6). Thereby, when the emitted beams are viewed in the lateral direction, the beams emitted from the first light emitting unit 11 and the beams emitted from the second light emitting unit 21 do not pass through the same positions, but the beams emitted from the first light emitting unit 11 and the beams emitted from the second light emitting unit 21 intersect. That is, when the emitted beams are viewed in the lateral direction, the beams of the second light emitting unit 21 can be emitted toward positions between the beams emitted from the first light emitting unit 11.

Thereby, for example, even when there is an object between the beams emitted from the first light emitting unit 11, the beams of the second light emitting unit 21 can increase the possibility that the object can be detected. As described above, in the laser radar mounting structure X, the accuracy of detecting objects around the vehicle V can be improved.

In the laser radar mounting structure X, the height position of the second light emitting unit 21 with respect to the first light emitting unit 11 is set such that the density of the beams emitted from the first light emitting unit 11 and the second light emitting unit 21 is most uniform in the specific region S. Here, when a predetermined region is uniformly irradiated with beams, the beams are more easily incident on an object in the predetermined region and the object can be detected more easily, as compared with the case where a part of the predetermined region is intensely irradiated with beams. In this way, the possibility that the object can be detected changes depending on whether the beams are uniformly emitted or unevenly emitted. Therefore, by setting the height position of the second light emitting unit 21 with respect to the first light emitting unit 11 such that the density of the beams is most uniform in the specific region S, it is possible to increase the possibility that an object can be detected in the specific region S compared with other regions. As described above, the laser radar mounting structure X can increase the possibility that an object can be detected in the specific region S set around the vehicle V.

The first laser radar 10 and the second laser radar 20 are mounted such that the first light emitting unit 11 and the second light emitting unit 21 are located on the reference axis K extending along the height direction. In this case, there is no horizontal parallax between the detection result of the first laser radar 10 and the detection result of the second laser radar 20. Thereby, for example, when performing a process of associating an object detected by the first laser radar 10 with an object detected by the second laser radar 20, it is possible to easily associate the two recognition results. In this way, since there is no horizontal parallax, various processes using the two detection results can be easily performed. Therefore, the laser radar mounting structure X facilitates the processes using the two detection results, thereby increasing the accuracy of detecting the object.

The detection directions of the first laser radar 10 and the second laser radar 20 are oriented toward the right side of the vehicle V. Thereby, the accuracy of detecting the object on the right side of the vehicle V can be improved. For example, at an intersection or the like, it is possible to accurately detect another vehicle or the like approaching the vehicle V from the right side of the vehicle V. Similarly, on the left side, the accuracy of detecting the object on the left side of the vehicle V can be improved with the first laser radar and the second laser radar facing the left side of the vehicle V.

The first laser radar 10 and the second laser radar 20 are mounted to the right side surface of the vehicle V. In this case, in the laser radar mounting structure X, the first laser radar 10 and the second laser radar 20 mounted to the right side surface of the vehicle V can accurately detect the object on the right side of the vehicle V without creating a blind spot. Similarly, on the left side, the first laser radar and the second laser radar mounted to the left side surface of the vehicle V can accurately detect the object on the left side of the vehicle V without creating a blind spot.

Although the embodiment of the present disclosure has been described above, the disclosure is not limited to the embodiment above. For example, the first laser radar 10 and the second laser radar 20 are not limited to the flash LiDAR. For example, the first laser radar 10 and the second laser radar 20 each may be a LiDAR of a type in which the irradiation direction of the beams is changed by a rotating mirror or the like. Further, the first laser radar 10 and the second laser radar 20 each may be a directional radar such as a phased eye sensor, rather than the LiDAR.

In the above embodiment, it is determined whether the density of the beams is uniform based on the ratio of voxels through which the beams pass. The present disclosure is not limited to this, and it may be determined whether the density of the beams is uniform by a method other than the method using voxels.

In the above embodiment, the detection directions of the first laser radar 10 and the second laser radar 20 are oriented toward the side (right side) of the vehicle V, but the detection directions are not limited to the direction oriented toward the side of the vehicle V. The detection directions of the first laser radar 10 and the second laser radar 20 may be oriented, for example, toward the front side or the rear side of the vehicle V.

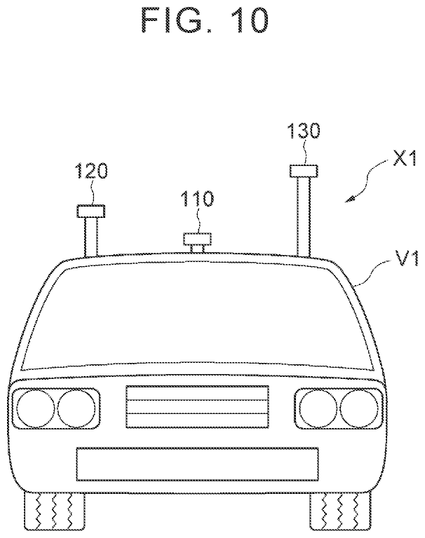

The first light emitting unit 11 of the first laser radar 10 and the second light emitting unit 21 of the second laser radar 20 are not limited to being provided on the same axis (reference axis K). Further, the number of laser radars mounted with the laser radar mounting structure X is not limited to two, that is, the first laser radar 10 and the second laser radar 20. For example, as a laser radar mounting structure X1 shown in FIG. 10, a structure may be adopted in which three laser radars of a first laser radar 110, a second laser radar 120, and a third laser radar 130 are mounted to a vehicle V1 with the height positions of the light emitting units of the laser radars being different from each other. In the example shown in FIG. 10, the detection directions of the first laser radar 110, the second laser radar 120, and the third laser radar 130 are oriented toward the front side of the vehicle V1. Further, the first laser radar 110, the second laser radar 120, and the third laser radar 130 are mounted to the ceiling of the vehicle V1 rather than the side surfaces of the vehicle V1. Note that the first laser radar 110, the second laser radar 120, and the third laser radar 130 are disposed at different positions in the horizontal direction. Even when the first laser radar 110 and the like are mounted with the laser radar mounting structure X1, the accuracy of detecting the object around the vehicle V1 (in front of the vehicle V1 in the example of FIG. 10) can be improved as with the laser radar mounting structure X in the embodiment.

At least a part of the embodiment and various modifications described above may be combined as appropriate.

What is claimed is:

1. A laser radar mounting structure for mounting a first laser radar and a second laser radar to a vehicle, the first laser radar and the second laser radar detecting an object around the vehicle, wherein:
a detection direction of the first laser radar and a detection direction of the second laser radar are the same as each other; and
the first laser radar and the second laser radar are mounted such that a first light emitting unit and a second light emitting unit are located at different height positions in a height direction of the vehicle, the first light emitting unit being a light emitting unit of the first laser radar, and the second light emitting unit being a light emitting unit of the second laser radar.

2. The laser radar mounting structure according to claim 1, wherein the height position of the second light emitting unit with respect to the first light emitting unit is set such that a density of beams emitted from the first light emitting unit and the second light emitting unit is most uniform in a specific region around the vehicle, the specific region being relatively set in advance with respect to the vehicle.

3. The laser radar mounting structure according to claim 1, wherein the first laser radar and the second laser radar are mounted such that the first light emitting unit and the second light emitting unit are located on a reference axis extending along the height direction of the vehicle.

4. The laser radar mounting structure according to claim 1, wherein the detection direction of the first laser radar and the detection direction of the second laser radar are oriented toward a side of the vehicle.

5. The laser radar mounting structure according to claim 4, wherein the first laser radar and the second laser radar are mounted to a side surface of the vehicle.
